(19) United States
(12) Patent Application Publication
(10) Pub. No.: US 2008/0119959 A1
(43) Pub. Date: May 22, 2008

(54) EXPRESSION OF EMOTIONS IN ROBOT

(76) Inventors: Cheonshu PARK, Daejeon-city (KR); Joung Woo RYU, Gyeonggi-do (KR); Joo Chan SOHN, Daejeon (KR); Young Jo CHO, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 11/930,659

(22) Filed: Oct. 31, 2007

(30) Foreign Application Priority Data
Nov. 21, 2006 (KR) 10-2006-0115460
Mar. 21, 2007 (KR) 10-2007-0027792

(51) Int. Cl. G06F 19/00

(52) U.S. Cl. 700/245

(57) ABSTRACT

A method and apparatus for expressing an emotion of a robot, which are applicable to different emotion robot platforms are provided. The method of expressing an emotion of a robot, the method includes: collecting emotion information by at least one internal or external sensor; generating an emotion and determining a behavior based on the collected information; determining an emotion expression, emotional intensity, and an action unit according to the generated emotion; generating an emotion expression document according to the determined emotion expression, emotional intensity, and action unit; analyzing the emotion expression document; and controlling the robot based on the initial status information of the robot and the generated emotion expression document.

### CROSS-REFERENCE TO RELATED PATENT APPLICATION

This application claims the benefit of Korea Patent Application No. 10-2006-0115460, filed on Nov. 21, 2006 and Korea Patent Application No. 10-2007-0017792, filed on Mar. 21, 2007 in the Korean Intellectual Property Office, the disclosures of which are incorporated herein in their entirety by reference.

### BACKGROUND OF THE INVENTION

1. Field of the Invention

The present invention relates to a method and apparatus for expressing emotions of a robot by providing emotion and action expression models with regard to emotions of the robot, which are generated in a variety of robot emotion expression platforms, thereby providing expression models accommodating various emotions, resulting in abundant emotional expressions.

The present invention was supported by the Information Technology (IT) Research & Development (R&D) program of the Ministry of Information and Communication (MIC) and the Institute for Information Technology Advancement (IITA) [Project No.: 2006-S-026-01, Development of the URC Server Framework for Proactive Robotic Services].

2. Description of Related Art

Much research into the emotional expression of robots has been conducted. In particular, main research areas include generation of emotions of robots similar to those of humans in response to a combination of external stimuli, selection of actions, and control of devices for expressing generated emotions of robots. Up to now, research into devices for controlling the expression of emotions of robots relating to facial expressions has been mainly carried out. Also, research has been conducted into devices for expressing emotions of robots by a combination of actions such as the movement of a body, arms, legs, eyes, and the like.

However, expression of emotions of robots using current external stimuli and information such as internal status vary depending on platforms. As a result, each platform needs its own emotion expression system due to the absence of a unified emotion expression model.

Therefore, Due to the absence of a unified emotion expression model of robots, although a robot expresses a generated emotion in one platform, another robot having different platform is not able to express the same emotion using expression devices such as a face, body, arms, legs, and the like. In more detail, recycling of emotions of robots is impossible due to incompatibility, regeneration of emotions of robots is necessary in accordance with robot platforms, or new expression methods are required.

Accordingly, in order to address these problems, it is necessary to express emotions of robots in different types of robot platforms by providing models with regard to the expression of emotions and actions, and an interface for analyzing models.

### SUMMARY OF THE INVENTION

The present invention provides an emotion expression model applicable to different types of various robot platforms.

The present invention also provides an apparatus for expressing emotions of a robot in order to express various actions with regard to emotions by sending an emotion expression document in accordance with an emotional action expression structure to a controller of each part of the robot, analyzing the emotion expression document, and driving an actuator corresponding to an action unit.

The present invention also provides a method of controlling a robot based on initial status information of the robot and an emotion expression document by collecting information, generating an emotion, deciding an action according to the generated emotion, determining an emotional expression, emotional intensity, and action unit, and generating and analyzing the emotion expression document.

According to an aspect of the present invention, there is provided an apparatus for expressing an emotion of a robot, the apparatus comprising: an emotion information receiving unit receiving an internal or external stimulus as emotion information; an emotion generating unit determining an initial status of the robot by using the emotion information received from the emotion information receiving unit and generating an emotion; a behavior determining unit determining a behavior corresponding to the emotion; an emotion expression managing unit generating an emotion expression document for expressing the emotion as an action of the robot by using the emotion, the initial status of the robot, and the behavior; an emotion expression processing unit receiving and analyzing the emotion expression document; and a robot controller controlling an individual action unit to execute an action according to the result of the emotion expression processing unit.

The emotion expression managing unit may comprise: an emotion expression generating unit generating a model with regard to the emotion generated by the emotion generating unit; an emotion action expression generating unit generating a model with regard to a basic action unit including the behavior determined by the behavior determining unit and the status information of the basic action unit; an emotion expression document generating unit generating a model with regard to the emotion and the behavior as the emotion expression document; and an emotion expression document transmitting unit transmitting the emotion expression document to the emotion expression processing unit.

The emotion expression managing unit may further comprise: an emotion action receiving unit receiving a message indicating that the action unit does not exist from the emotion expression processing unit, if the action unit to be controlled by the emotion expression processing unit is not identical or does not exist; and a sub unit generating unit generating a model with regard to sub unit information necessary if the action unit with regard to the behavior determined by the behavior determining unit does not exist, wherein the emotion expression document further includes a sub unit status information model.

The emotion expression processing unit may comprise: an emotion expression document receiving unit receiving the emotion expression document generated by the emotion expression managing unit; a document analyzing unit analyzing the emotion expression document; an action unit message transmitting unit, if no action unit corresponds to the emotion expression document analyzed by the document analyzing unit, transmitting an message indicating that no action unit exists to the emotion expression managing unit in order to generate a sub action unit; and a control command transmitting unit transmitting a control command to the robot controller based on the command analyzed by the document analyzing unit.

According to another aspect of the present invention, there is provided an apparatus for instructing expression of an emotion of a robot, the apparatus comprising: a meta information expression unit providing a model analyzing a part that needs to be controlled and determining whether the part is suitable for an action unit in order to control the robot; and an emotion expression unit providing two models respectively with regard to emotions and behavior based on meta information.

The meta information expression unit may comprise: an emotion type determining unit determining whether the emotion comprises a main emotion type or a composite emotion type; an action type determining unit determining whether the behavior comprises a basic action type or a sub action type; and an action unit determining unit determining an action unit with regard to the emotion.

The emotion expression unit may comprise: a main emotion expressing unit, if only one emotion is generated, defining the emotion as a representative emotion and demonstrating the representative emotion; a composite emotion expression unit, if two or more emotions are generated, providing a model for expressing the two or more composite emotions; an emotion intensity expression unit describing an intensity of the emotion generated using a numerical value; and an action expression unit providing an expression model necessary for expressing behavior.

The action expression unit may comprise: an action unit status information expression unit describing an initial status information of a robot unit; a basic action unit expression unit expressing information on an action unit generated based on the behavior generated by the behavior determining unit; and a sub action unit expression unit, when the action unit generated based on the behavior generated by the behavior determining unit does not exist in an emotion robot platform, expressing information on a unit as a means of substitution for the action unit.

The emotion expression unit from which the action expression unit is separated may assign an intrinsic ID to a main emotion expression unit and a composite emotion expression unit of the emotion expression unit, and describe the action expression unit using a reference that is mapped to each ID.

According to another aspect of the present invention, there is provided a method of expressing an emotion of a robot, the method comprising: collecting emotion information by at least one internal or external sensor; generating an emotion and determining a behavior based on the collected information; determining an emotion expression, emotional intensity, and an action unit according to the generated emotion; generating an emotion expression document according to the determined emotion expression, emotional intensity, and action unit; analyzing the emotion expression document; and controlling the robot based on the initial status information of the robot and the generated emotion expression document.

The generating of the emotion and determining of the behavior may comprise: separately generating the emotion as a main emotion and composite emotions.

The analyzing of the emotion expression document may comprise: if it is determined that the action unit does not exist, regenerating the emotion expression document including a sub unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system for generating and processing an emotional expression of a robot according to an embodiment of the present invention;

FIG. 2 is a detailed block diagram of an emotion expression managing unit shown in FIG. 1;

FIG. 3 is a detailed block diagram of an emotion expression processing unit shown in FIG. 1;

FIG. 4 is a block diagram of an emotion expression order according to an embodiment of the present invention;

FIG. 5 is a block diagram of an emotion expression order according to another embodiment of the present invention;

FIG. 6 is a block diagram of an emotion expression order according to another embodiment of the present invention;

FIG. 7A illustrates code representing an emotion expression document generated by the emotion expression managing unit shown in FIG. 1 according to an embodiment of the present invention;

FIG. 7B illustrates code including references representing the emotion expression document generated by the emotion expression managing unit shown in FIG. 1 according to another embodiment of the present invention; and

FIG. 8 is a flowchart illustrating a method of expressing emotions of a robot according to an embodiment of the present invention.

### DETAILED DESCRIPTION OF THE INVENTION

Exemplary embodiments of the present invention will now be described in detail with reference to the accompanying drawings. In the description of the present invention, when a detailed description of known functions or structures is determined to be unnecessary and not to clarify the subject matter of the present invention, the detailed description will be omitted. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

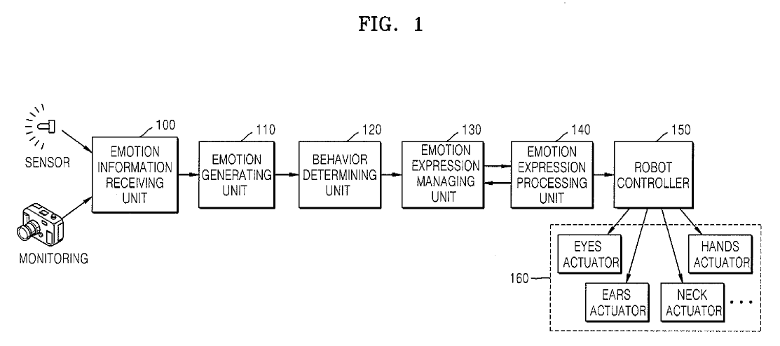

FIG. 1 is a block diagram of a system for generating and processing an emotional expression of a robot according to an embodiment of the present invention. Referring to FIG. 1, an emotion information receiving unit 100 detects an internal or external stimulus using a sensor or monitors the external stimulus using a camera or an image pickup device attached to the system. If the system uses a pressure sensor, when a pressure greater than a threshold point that is established by a user is applied to the system, i.e., when a shock is applied to the system, the degree of the shock is changed into a numerical value. An emotion generating unit 110 receives the numerical value and generates an emotion such as “pain” and/or “surprise.”

According to another embodiment, if the system uses a temperature sensor, when an external temperature exceeds a predetermined value, the temperature is changed into a numerical value using the temperature sensor. The emotion generating unit 110 receives the numerical value and generates an emotion appropriate for a temperature change.

According to another embodiment, if the system uses an optical sensor, a sudden change in light brightness makes the robot have a wry face.

According to another embodiment, if the camera or the image pickup device are used to monitor an external scene, a sudden change in an image also generates an emotion of “surprise” or the like.

It will be understood by those of ordinary skill in the art that a device for accommodating external stimuli can be one of a variety of devices in addition to the sensor or monitor (the camera or the image pickup device) illustrated in FIG. 1.

If the emotion information receiving unit 100 receives emotion information by using the sensor or the like for accommodating external stimuli, the emotion generating unit 110 uses the emotion information to generate emotions such as “sad”, “fear”, “disgust”, “anger”, “surprise”, “shame”, “joy” and the like. The emotion generating unit 110 further determines an initial status of the robot, which is important in the expression of real emotion. For example, when the robot with half-closed eyes expresses an emotion “surprise”, a failure of the emotion generating unit 110 in determining the initial status of the robot causes overload in an actuator that controls the eyes of the robot. The emotion generating unit 110 determines the initial status of the robot in order to prevent such an overload, which results in a decision on a range of operation of the actuator.

If the emotion generating unit 110 generates the emotions, a behavior determining unit 120 determines behavior suitable for the emotions. For example, if the emotion generating unit 110 generates the emotion “surprise”, the behavior determining unit 120 determines that the behavior of the robot should be to open its eyes wide and make its mouth round by driving the actuators.

An emotion expression managing unit 130 generates an emotion expression document to express the emotions generated by the emotion generating unit 110 as actions of the robot by using the emotions, the initial status of the robot, and the behavior determined by the behavior determining unit 120. The detailed description of the emotion expression document will be described later.

If the emotion expression managing unit 130 generates the emotion expression document, an emotion expression processing unit 140 analyzes in detail the emotion expression document. In more detail, the emotion expression processing unit 140 determines how to process the emotions according to the emotion expression document in order to express the emotions and sends the determination to a robot controller 150.

The robot controller 150 controls eye actuators, hand actuators, ear actuators and the like to express the emotions based on the processing determined by the emotion expression processing unit 140.

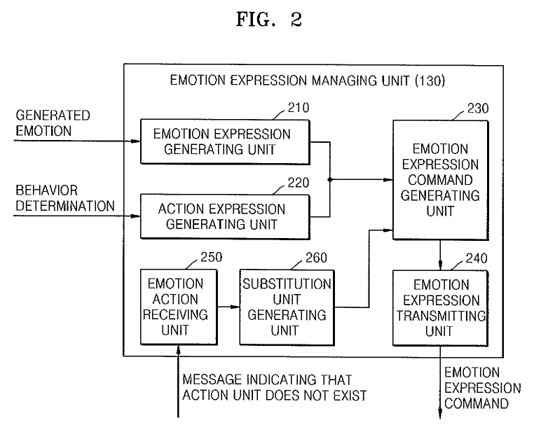

The emotion expression managing unit 130 will now be described with reference to FIG. 2. FIG. 2 is a detailed block diagram of the emotion expression managing unit 130 shown in FIG. 1.

An emotion expression generating unit 210 and an emotion action expression generating unit 220 of the emotion expression managing unit 130 receive the emotions generated by the emotion generating unit 110 and the behavior determined by the behavior determining unit 120, respectively.

The emotion expression generating unit 210 generates models of the emotions such as “sad”, “joy”, “fear”, “disgust”, “anger”, “surprise”, “shame” and the like. The emotion action expression generating unit 220 generates each model of a basic action unit including the behavior determined by the behavior determining unit 120 and status information of the basic action unit. The models have a variety of different types and will be described later. The models are sent to an emotion expression document generating unit 230.

An emotion action receiving unit 250 receives a message indicating that an action unit does not exist from the emotion expression processing unit 140 when action units to be controlled are not identical to each other or do not exist. When the emotion action receiving unit 250 receives the message indicating that the action unit does not exist, it sends a signal to a substitute generating unit 260 to generate a substitution unit model. The substitution unit generating unit 260 generates the substitution unit model and sends it to the emotion expression document generating unit 230.

The emotion expression document generating unit 230 collects all the models generated by the emotion expression generating unit 210, the emotion action expression generating unit 220, and the substitution unit generating unit 260 and generates a single emotion expression document. The emotion expression document is sent to the emotion expression processing unit 140 via an emotion expression document transmitting unit 240.

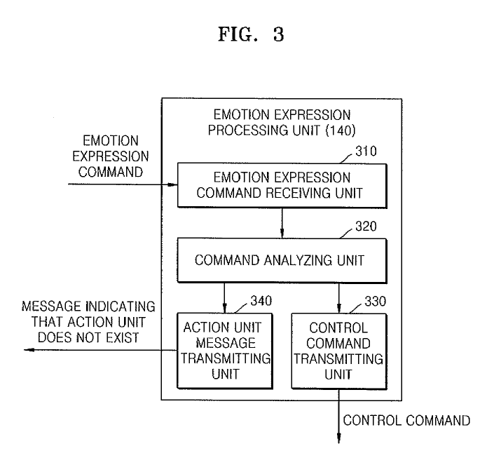

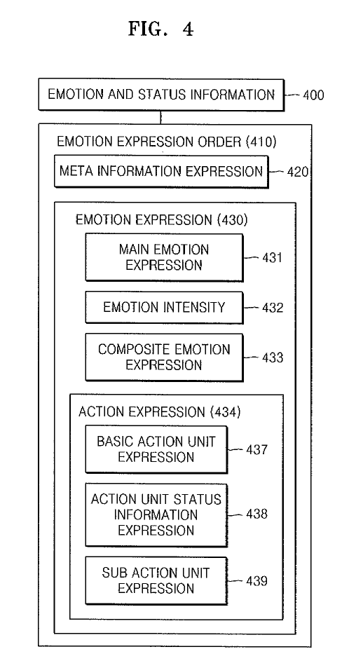

FIG. 3 is a detailed block diagram of the emotion expression processing unit 140 shown in FIG. 1. Referring to FIG. 3, the emotion expression processing unit 140 can control an actuator of a specific portion of the robot. The emotion expression processing unit 140, which is a part of a controller including a processor with simple processing capabilities, provides an interface for transmission/receipt of data with the emotion expression managing unit 130, interprets and analyzes an order, and transmits a command to the robot controller 150 to control an action unit using a controller of a part of the robot according to emotions and action expression information described in emotion expression orders 410, 510, and 610, each shown in FIGS. 4 through 6.

The emotion expression processing unit 140 comprises an emotion expression document receiving unit 310 that receives the emotion expression document generated by the emotion expression managing unit 130.

The emotion expression document receiving unit 310 sends the emotion expression document to a document analyzing unit 320 to analyze the emotion expression document. The document analyzing unit 320 analyzes the emotion expression document, determines how to control each part of the robot, generates a command for driving the actuator of each part of the robot, and sends the command to a control command transmitting unit 330.

The control command transmitting unit 330 transmits the command for driving the actuator of each part of the robot generated by the document analyzing unit 320 to the robot controller 150. The control command transmitting unit 330 provides an interface for transmitting a message ACK indicating that an action unit does not exist if the action unit does not exist in the controller of each part of the robot when processing the emotion expression document.

Although not shown in detail, the robot controller 150 receives the command and drives the actuator of each part of the robot in order to properly express the generated emotions.

The document analyzing unit 320 may sometimes find no proper action unit for expressing the generated emotions as a result of analyzing the emotion expression document. At this time, the document analyzing unit 320 transmits the message ACK indicating that the action unit does not exist to the emotion action receiving unit 250 of the emotion expression managing unit 130 via the action unit message transmitting unit 340 in order to notify the emotion expression managing unit 130 that the robot does not carry out the action and has no action unit for expressing the emotions.

The emotion expression document in combination with the models generated by the emotion expression generating unit 210 of the emotion expression processing unit 130, the emotion action expression generating unit 220, and the substitution unit generating unit 260 will now be described in more detail.

FIGS. 4 through 6 are block diagrams of emotion expression orders according to an embodiment of the present invention. Referring to FIGS. 4 through 6, the emotion expression documents are classified as meta information expression units 420, 520, and 620, emotion expression units 430, 530, and 630, and action expression units 434, 635, and 639.

Each of the meta information expression units 420, 520, and 620 describes meta information about an action unit to be selected by the emotion expression processing unit 130. In more detail, each of the meta information expression units 420, 520, and 620 describes an emotion type used to determine whether each emotion expressed by the emotion expression units 430, 530, and 630 is a main emotion type or a composite emotion type. Each of the meta information expression units 420, 520, and 620 describes an action type used to determine an action corresponding to an emotion. In more detail, each of the meta information expression units 420, 520, and 620 describes a basic action expression type for basic actions with regard to the behavior determined by the behavior determining unit 120 and a sub action expression type for a substitution unit. Each of the meta information expression units 420, 520, and 620 describes a representative action unit as basic action expression means.

Each of the meta information expression units 420, 520, and 620 provides a model used to analyze a portion necessary for controlling the robot by using the emotion expression processing unit 140 and to determine whether the portion is suitable for an action unit.

Each of the emotion expression units 430, 530, and 630 provides an action expression model with regard to the emotions generated by the emotion generating unit 110 and the behavior generated by the behavior determining unit 120. Each of the emotion expression units 430, 530, and 630 comprises main emotion expression units 431, 531, and 631, emotion intensity expression units 432, 533, 537, 633, 637, and composite emotion expression units 433, 535, and 636, and action expression units 434, 540, 635, 639.

When the emotion generating unit 110 generates a single emotion, each of the main emotion expression units 431, 531, and 631 defines the emotion as a representative emotion and describes the representative emotion. Each of the emotion intensity expression units 432, 533, 537, 633, 637 describes intensity of each of emotions using a numerical value. For example, if the emotion generating unit 110 generates a single emotion, each of the emotion intensity expression units 432, 533, 537, 633, 637 describes the intensity of a main emotion as “100”. However, if the emotion generating unit 110 generates composite emotions, each of the emotion degree expression units 432, 533, 537, 633, 637 determines an emotion having the greatest intensity as a main emotion and describes the other composite emotions using other intensity values.

Each of the composite emotion expression units 433, 535, and 636 provides a model used to express one or more emotions generated by the emotion generating unit 110. In more detail, the emotion generating unit 110 generates composite emotions, for example, both “surprise” and “joy”. A model capable of simultaneously expressing more various emotions is provided, so that the robot can more easily express various emotions. Furthermore, various action expression means that can be supported in emotion robot platforms are used to express various emotions differently.

Each of the action expression units 434, 540, 635, 639 provides an expression model with regard to the action unit necessary for expressing emotions.

Each of basic action unit expression units 437 and 541 describes basic operations with regard to emotions generated in emotion robot platforms.

Each of action unit status information expression units 438 and 543, which are expression models used to describe initial status information of an action unit, analyzes the initial status information of the action unit in order to exactly express actions with regard to emotions and reduces errors as much as possible. The advantage of initial status information is to prevent any possible overloads. In other words, but for such initial status information, the system may be overloaded when a control command is executed without any initial status information of the action unit.

Each of sub action unit expression units 439 and 545 provides an expression model used to describe information about a unit to be used as substitution means when the action units generated based on the behavior generated by the behavior determining unit 120 is not included in emotion robot platforms. In more detail, it is common that the action units are not identical to each other in different emotion robot platforms. In this case, the sub action unit expression unit 439 and 545 can only properly express actions with regard to emotions in different emotion robot platforms. In this regard, the sub action unit expression units 439 and 545 increase flexibility in the action expression between different emotion robot platforms.

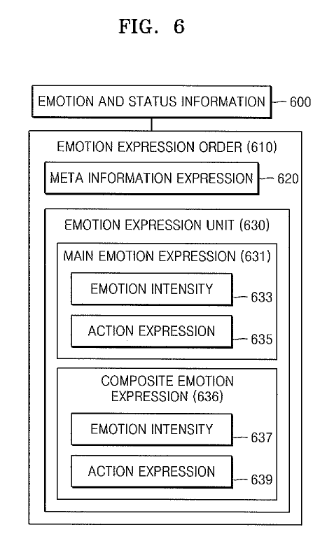

Although the basic action unit expression unit, action unit status information expression unit, and the sub action unit expression unit are not shown in FIG. 6, the three expression units can be included in the action expression units 635 and 639.

The characteristics of the emotion expression orders shown in FIGS. 4 through 6, i.e., each emotion expression model of the present invention, will now be described.

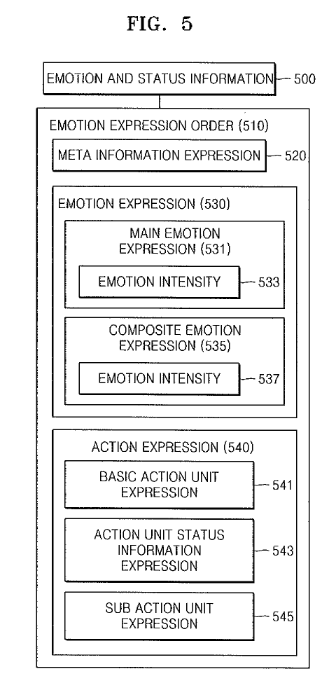

The action expression unit 434 and the action expression units 635 and 639 are included in the emotion expression units 430 and 630 in the emotion expression orders 410 and 610 shown in FIGS. 4 and 6, respectively, whereas the emotion expression unit 530 and the action expression unit 540 are completely separated from each other in the emotion expression orders 510 shown in FIG. 5 in order to independently express emotions.

In more detail, the emotion expression orders 510 assigns an intrinsic ID to each of a main emotion and composite emotions, defines an ID reference that is mapped to each ID, and describes the action expression unit 540 in order to connect the emotion expression unit 530 and the action expression unit 540.

Meanwhile, the action expression unit 434 and the action expression units 635 and 639 are included in the emotion expression units 430 and 630 each including in the main emotion expression units 431 and 631 and the composite emotion expression units 433 and 636, respectively. That is, a single emotion is expressed through the action expression units 434, 635, and 639 in the emotion expression orders 410 and 610.

The emotion intensity expression unit 432 included in the emotion expression unit 430 generates the same number of intrinsic IDs as the emotions expressed by the main emotion expression unit 431 and the composite emotion expression unit 433 and classifies the intrinsic IDs.

The emotion expression processing unit 140 analyzes the emotion expression orders 410, 510, and 610 and sends the control command to the robot controller 150.

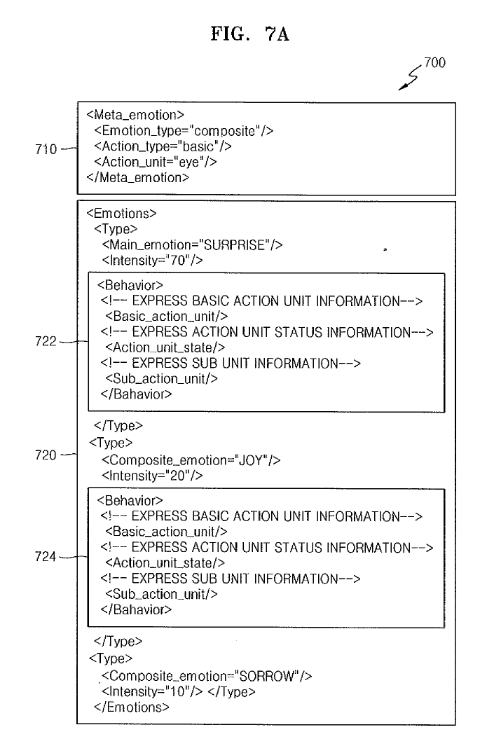

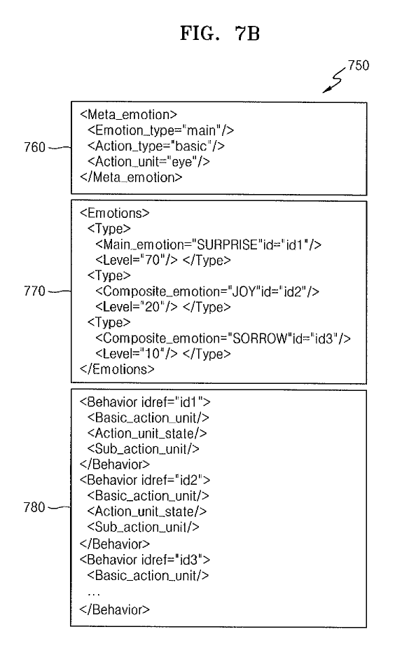

FIG. 7A illustrates an order 700 by the emotion expression document generated by the emotion expression managing unit 130 according to an embodiment of the present invention. Referring to FIG. 7A, the emotion expression document is based on extensible markup language (XML) syntax and the emotion expression order model shown in FIG. 6.

The order 700 includes a meta emotion expression unit 710. In the present invention, an analysis of meta information indicates that “composite” emotions having a “basic” action type are generated, and “eyes” are to be driven as a unit of the robot.

A part corresponding to the emotion expression unit 720 is classified into a main emotion expression unit and two composite emotion expression units using <Type> and </Type>. A main emotion is set as “surprise” with the intensity “70” in the main emotion expression unit. An emotion “joy” with the intensity “20” is expressed in the first composite emotion unit. An emotion “sad” with the intensity “10” is expressed in the second composite emotion unit.

Two respective parts corresponding to the action expression units 722 and 724 are classified using <Behavior> and </Behavior>, which describes an action taken according to each of basic action unit information, action unit status information expression, and sub unit information expression in each of the action expression units 722 and 724.

FIG. 7B illustrates an order 750 including references by the emotion expression document generated by the emotion expression managing unit 130 shown in FIG. 1 according to another embodiment of the present invention.

In more detail, referring to FIG. 7B, the order 750 is based on the emotion expression order 510 shown in FIG. 5.

The order 750 includes a meta emotion expression unit 760. In the present invention, an analysis of meta information indicates that a “main” emotion having a “basic” action type is generated, and “eyes” are to be driven as a unit of the robot.

A part corresponding to an emotion expression unit 770 is classified into a main emotion expression unit and two composite emotion expression units using <Type> and </Type>. A main emotion is set as “surprise” with the intensity “70” in the main emotion expression unit. An emotion “joy” with the intensity “20” is expressed in the first composite emotion unit. An emotion “sad” with the intensity “10” is expressed in the second composite emotion unit. The “intensity” shown in FIG. 7A is substituted as an indicator “level” in the order 750. However, a proper indicator can be used to indicate the order according to another embodiment of the present invention.

In comparison with the orders 700 and 750, emotions are established and each emotion has a different id in the order 750. In more detail, the main emotion is established with id=id1, the first composite emotion is established with id=id2, and the second composite emotion is established with id=id3. These reference ids are required to classify the order model shown in FIG. 7B into the emotion expression unit 770 and the action expression unit 780. A reference such as <Behavior idref=“id1”> is used to determine an emotion to be expressed by the action expression unit 780 in order to express an action. The emotion to be expressed from idref=“id1” is recognized as “surprise” and is separated from other composite emotions.

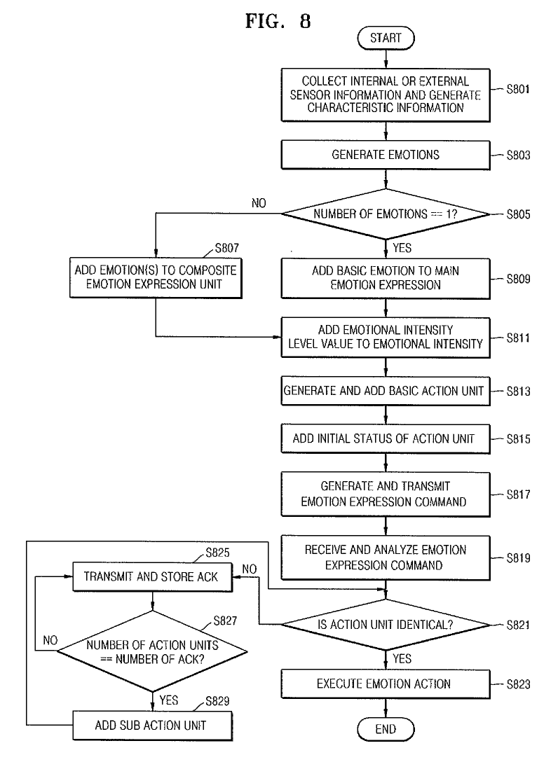

FIG. 8 is a flowchart illustrating a method of expressing emotions of a robot according to an embodiment of the present invention. Referring to FIG. 8, in Operation 801, internal or external sensor information is collected and characteristic information of the internal or external sensor information is generated. In Operation 803, emotions are generated based on the characteristic information. If it is determined in Operation 805 that a single emotion is generated, in Operation 809, a basic emotion is added to a main emotion expression unit of an emotion expression document. However, if two or more emotions are generated, in Operation 807, these emotions are added to a composite emotion expression unit.

As such, if the emotions are added to the main emotion expression unit and the composite emotion expression unit, in Operation 811, an emotional intensity level value is added to each emotion. At this time, if a main emotion that is the single emotion is generated, a whole emotional intensity value is assigned to the main emotion, whereas if the composite emotions are generated, an emotional intensity value is properly assigned to each composite emotion.

In Operation 813, a basic action unit is determined and is added to the emotion expression document. In Operation 815, an initial status of the action unit is obtained and is added to the emotion expression document.

In Operation 817, the emotion expression document is completely generated and is transmitted to an emotion expression processing unit. In Operation 819, the emotion expression document is analyzed. In Operation 821, meta information of the emotion expression document is analyzed and it is determined whether an action unit is identical to information included in the meta information. If the information included in the meta information is identical to the action unit, in Operation 823, an emotion action is executed according to the emotion expression document. If the information included in the meta information is not identical to the action unit, a message ACK indicating that an identical action unit does not exist is generated. In Operation 825, the number of ACK messages repeatedly transmitted is stored. In Operation 827, the number of ACK messages is compared to the number of total action units, and, if both numbers are identical to each other, it is determined that there is no proper action unit. In Operation 829, a sub action unit is added.

Regardless of the number of action units, it is possible to select the sub action unit.

The present invention provides a method and apparatus for expressing emotions generated in a variety of robot platforms using different methods, making it possible to express a larger variety of emotions and providing compatibility between different robot platforms.

The present invention has been particularly shown and described with reference to exemplary embodiments thereof. While specific terms are used, the terms should be considered in descriptive sense only and not for purposes of limitation of the meanings of the terms or the scope of the invention. Therefore, it will be understood by those of ordinary skill in the art that various changes in form and details may be made therein without departing from the spirit and scope of the invention as defined by the appended claims.

What is claimed is:

1. An apparatus for expressing an emotion of a robot, the apparatus comprising:
an emotion information receiving unit receiving an internal or external stimulus as emotion information;
an emotion generating unit determining an initial status of the robot by using the emotion information received from the emotion information receiving unit and generating an emotion;
a behavior determining unit determining a behavior corresponding to the emotion;
an emotion expression managing unit generating an emotion expression document for expressing the emotion as an action of the robot by using the emotion, the initial status of the robot, and the behavior;
an emotion expression processing unit receiving and analyzing the emotion expression document; and
a robot controller controlling an individual action unit to execute an action according to the result of the emotion expression processing unit.

2. The apparatus of claim 1, wherein the emotion expression managing unit comprises:
an emotion expression generating unit generating a model with regard to the emotion generated by the emotion generating unit;
an emotion action expression generating unit generating a model with regard to a basic action unit including the behavior determined by the behavior determining unit and the status information of the basic action unit;
an emotion expression document generating unit generating a model with regard to the emotion and the behavior as the emotion expression document; and
an emotion expression document transmitting unit transmitting the emotion expression document to the emotion expression processing unit.

3. The apparatus of claim 2, wherein the emotion expression managing unit further comprises:
an emotion action receiving unit receiving a message indicating that the action unit does not exist from the emotion expression processing unit, if the action unit to be controlled by the emotion expression processing unit is not identical or does not exist; and
a sub unit generating unit generating a model with regard to sub unit information necessary if the action unit with regard to the behavior determined by the behavior determining unit does not exist,
wherein the emotion expression document further includes a sub unit status information model.

4. The apparatus of claim 1, wherein the emotion expression processing unit comprises:
an emotion expression document receiving unit receiving the emotion expression document generated by the emotion expression managing unit;
a document analyzing unit analyzing the emotion expression document;
an action unit message transmitting unit, if no action unit corresponds to the emotion expression document analyzed by the document analyzing unit, transmitting an message indicating that no action unit exists to the emotion expression managing unit in order to generate a sub action unit; and
a control command transmitting unit transmitting a control command to the robot controller based on the command analyzed by the document analyzing unit.

5. An apparatus for instructing expression of an emotion of a robot, the apparatus comprising:
a meta information expression unit providing a model analyzing a part that needs to be controlled and determining whether the part is suitable for an action unit in order to control the robot; and
an emotion expression unit providing two models respectively with regard to emotions and behavior based on meta information.

6. The apparatus of claim 5, wherein the meta information expression unit comprises:
an emotion type determining unit determining whether the emotion comprises a main emotion type or a composite emotion type;
an action type determining unit determining whether the behavior comprises a basic action type or a sub action type; and
an action unit determining unit determining an action unit with regard to the emotion.

7. The apparatus of claim 5, wherein the emotion expression unit comprises:
a main emotion expressing unit, if only one emotion is generated, defining the emotion as a representative emotion and demonstrating the representative emotion;
a composite emotion expression unit, if two or more emotions are generated, providing a model for expressing the two or more composite emotions;
an emotion intensity expression unit describing an intensity of the emotion generated using a numerical value; and
an action expression unit providing an expression model necessary for expressing behavior.

8. The apparatus of claim 7, wherein the action expression unit comprises:
an action unit status information expression unit describing an initial status information of a robot unit;
a basic action unit expression unit expressing information on an action unit generated based on the behavior generated by the behavior determining unit; and
a sub action unit expression unit, when the action unit generated based on the behavior generated by the behavior determining unit does not exist in an emotion robot platform, expressing information on a unit as a means of substitution for the action unit.

9. The apparatus of claim 7, wherein the emotion expression unit from which the action expression unit is separated assigns an intrinsic ID to a main emotion expression unit and a composite emotion expression unit of the emotion expression unit, and describes the action expression unit using a reference that is mapped to each ID.

10. A method of expressing an emotion of a robot, the method comprising:
collecting emotion information by at least one internal or external sensor;
generating an emotion and determining a behavior based on the collected information;
determining an emotion expression, emotional intensity, and an action unit according to the generated emotion;
generating an emotion expression document according to the determined emotion expression, emotional intensity, and action unit;
analyzing the emotion expression document; and
controlling the robot based on the initial status information of the robot and the generated emotion expression document.

11. The method of claim 10, wherein the generating of the emotion and determining of the behavior comprises: separately generating the emotion as a main emotion and composite emotions.

12. The method of claim 10, wherein the analyzing of the emotion expression document comprises: if it is determined that the action unit does not exist, regenerating the emotion expression document including a sub unit.
